(19) United States
(12) Patent Application Publication
(10) Pub. No.: US 2019/0247151 A1
(43) Pub. Date: Aug. 15, 2019

(54) DENTAL PROSTHETIC SYSTEM WITH DRY-FIT CAPABILITY

(71) Applicant: DENTSPLY SIRONA Inc., York, PA (US)

(72) Inventors: Eric BRIGHT, Fiskdale, MA (US); Alexander YARMARKOVICH, Swampscott, MA (US); Anton VENDLAND, Nashua, NH (US); Najib KHALIL, Watertown, MA (US)

(73) Assignee: DENTSPLY SIRONA Inc., York, PA (US)

(21) Appl. No.: 16/335,761

(22) PCT Filed: Sep. 26, 2017
(86) PCT No.: PCT/US17/53390

§ 371 Date: Mar. 22, 2019

Related U.S. Application Data
(60) Provisional application No. 62/400,175, filed on Sep. 27, 2016.

(51) Int. Cl. A61C 8/00; A61C 5/30

(52) U.S. Cl. CPC A61C 8/005; A61C 13/2656; A61C 5/30

(57) ABSTRACT

A dental restorative system (10) includes a dental prosthesis (21), a support surface (13a or 30) and a cement gap (22) between those opposing surfaces. A number of dry-fit features (11) can be placed upon the support surface (13a or 30) or the prosthesis (21) such that the features (11) extend into cement gap (22). Dry-fit features (11) serve to position the prosthesis (21) during a dry-fit procedure and during subsequent cementing of the prosthesis (21) to its support surface (13a or 30).

### FIELD OF THE INVENTION

This invention is generally related to a dental prosthetic system such as a dental implant system of the type having an implant body, an abutment and a dental prosthetic. More particularly, the invention relates to a dental prosthetic may be temporarily be placed upon a support surface such as an abutment or a prepared tooth in a removably secure manner in order to ascertain proper positioning of the dental prosthesis before permanent installation.

### BACKGROUND

It is known in the dental restorative arts to use a dental prosthesis such as a crown, bridge, inlay, onlay or an implant. A tooth is often prepared by excavating diseased or damaged material, creating a prepared tooth surface. A crown or other dental prosthesis can then be fit to the prepared surface. In the case of a dental implant, the implant body is secured in a jaw bone, and an abutment having a prosthesis supporting surface is then affixed to the implant body. The prosthesis is then affixed to the abutment supporting surface.

Whether a crown, implant or other restorative system is used, the restoring prosthesis is often dry-fit by the dental practitioner. That is, the prepared restorative prosthesis is placed over the support surface to make certain of its fit and position in the oral cavity. Often and normally, the prosthesis is then cemented to the support surface. A cement gap or a space is intentionally created between the prosthesis and the support surface in order to provide room for the cement used in the affixing step.

By “dental prosthesis” or “dental prosthetic” and similar terms, it is intended herein to include any dental restorative that is dry-fit prior to permanent affixation. This includes without limitation, crowns, bridges, inlays and the like without limitation. The invention is often exemplified herein with reference to a crown, but such is not intended to limit the invention to only crowns.

It is important that the dry-fit and the final cementing or the prosthesis is accomplished with precision so that the permanent affixation of the prosthesis is in substantially the same position as the approved dry-fit position. Previously, the two parts (the support surface and the prosthesis) do not dry-fit together snugly, and may in fact fall apart if not physically held together during the procedure, prior to cementation. Also, the two parts can move relative to one another by an amount equal to the size of the cement gap. This effect happens translationally, but there is a similar effect rotationally. As a result, adjustments made to the crown during the dry-fit may be off by the amount of the cement gap after cementation. See FIGS. 3 and 4 which depict the situation with the prior art.

During prosthesis try-in in a doctor's office, and prior to cementation, the doctor needs to hold the crown in place or risk it falling off the abutment (or other support substructure), possibly falling down the patient's throat. In addition, the act of holding the part in place obstructs the doctor's view of the part and reduces their ability to evaluate the correct fit and esthetic quality. The features of the present invention hold the crown in place without the need for a doctor to hold it in place (typically with their finger).

This problem sometimes doesn't show itself with traditional dental manufacturing techniques. It turns out that those techniques often include precision errors that cause the parts not to properly fit by an amount that allows them to stay in place without being held by the doctor. With more precise manufacturing techniques, as in the present invention, these errors are not large enough to potentially keep the restoration in place.

According to the invention, these features not only provide a predictable dry-fit retention, they also allow for a more precise manufacturing technique to have this similar physical characteristic as less-precise parts often display.

During the same crown try-in procedure, the doctor will make adjustments to the crown/restoration to make it properly fit relative to neighboring teeth and other anatomy. This is done by making small modifications to the restoration until the doctor determines that it fits correctly.

After such modification, the doctor removes the now-adjusted crown adds a layer of cement and places the part back in the patient's mouth as part of the final cementation step. But, the final cemented position could be different from the position that the doctor made the final adjustments using. The difference could be up to the size of the cement gap, both translationally and rotationally. The ultimately results in a poor fit in the patient's mouth, causing the doctor to make an additional set of adjustments if possible.

An additional benefit of the present invention is that it reduces the size of these potential errors to the same amount as the machining error of the added features. That machining error is significantly smaller than the cement gap of the parts.

### SUMMARY

A dental implant system includes a dental implant body configured to be securable in a jaw bone; an abutment secured or securable to said implant body and having a first end affixable to said implant body, and a second end configured to receive a dental prosthetic; and, a dental prosthetic receivable on and cementable to said second end of said abutment, such that an outer surface of second end of said abutment is positioned opposite to an inner surface of said dental prosthetic when said dental prosthetic is received on said second end of said abutment. A cement gap is configured between said abutment and said dental prosthetic when said dental prosthetic is received on said abutment; and the outer surface of said abutment is provided with a plurality of regularly or irregularly spaced dry-fit features, such that when said dental prosthetic is received on said second end of said abutment, said dry-fit features create a removable friction fit between said outer surface of said second end of said abutment and said dental prosthetic.

There is also provided according to the present invention, a dental implant system including a dental implant body configured to be securable in a jaw bone; an abutment secured or securable to said implant body and having a first end affixable to said implant body, and a second end configured to receive a dental prosthetic; and, a dental prosthetic receivable on and cementable to said second end of said abutment, such that an outer surface of second end of said abutment is positioned opposite to an inner surface of said dental prosthetic when said dental prosthetic is received on said second end of said abutment. A cement gap is configured between said abutment and said dental prosthetic when said dental prosthetic is received on said abutment; and wherein said inner surface of said dental prosthetic is provided with a plurality of regularly or irregularly spaced dry-fit features, such that when said dental prosthetic is received on said second end of said abutment, said dry-fit features create a removable friction fit between said inner surface of said dental prosthetic and said second end of said dental abutment.

In another embodiment of the invention, a dental restoration includes a prepared tooth having a preparation surface; and a dental prosthetic having an inner surface receivable on said preparation surface. A cement gap is configured between said preparation surface and said dental prosthetic when said dental prosthetic is received on said preparation surface; and wherein said inner surface of said dental prosthetic is provided with a plurality of regularly or irregularly spaced dry-fit features, such that when said dental prosthetic is received on said preparation surface, said dry-fit features create a removable friction fit between said inner surface of said dental prosthetic and said preparation surface. The inner surface of a crown is designed to be slightly larger than the outer surface of the abutment it is intended to be cemented to. This is to provide room for the cement. This extra space is called a cement gap. See FIG. 2.

According to the present invention, there is created an article of manufacture that adds dry-fit features such as spherical or other shapes of bumps or protrusions to the surface of the abutment, the interior of a prepared dental prosthesis or the like, to both locate the abutment, prepared tooth surface or other support structure, and the crown relative to one another. This provides sufficient frictional fit between the two parts such that the crown doesn't fall off the abutment during dry-fit.

The dry-fit features according to the invention may be placed on any opposing surface between the dental restorative prosthetic and the support surface upon which it is to be dry-fit prior to cementation. It will be understood that the dry-fit features are intended to be protrusions of any shape or size, whether regularly shaped or irregularly shaped, and all such features will be collectively referred to by the term dry-fit features, bumps or the like for simplicity of this disclosure.

A method for retaining crowns to abutment during dry-fitting includes calculating appropriate (not necessarily optimal) places to put the dry-fit features to achieve dry-fit retention; adding the dry-fit features to the abutment model (or crown model); and, manufacturing the two parts together with the added bumps.

### BRIEF DESCRIPTION OF THE DRAWINGS

Detailed Description of the Invention

According to the present invention, a dental restoration is achieved with the ability to secure a dental prosthesis such as a crown, in the oral cavity of the patient prior to cementation or other affixation of the prosthetic. During dry-fit, dry-fit features assure a snug or tight fit between the prosthesis and its support surface (such as a dental abutment or a prepared surface of a tooth) such that proper placement of the restorative is accomplished after the dry-fitting procedure.

A dental prosthesis system having such dry-fit retention features according to the invention is shown by way of example by the number 10 on the attached drawings. It will be appreciated that dry-fit features or bumps 11 may be positioned upon the interior of the dental prosthesis 12; an exterior support surface such as abutment 13 or prepared tooth surface 14; or, both simultaneously. For simplicity, the dry-fit features 11 will be exemplified herein and on the drawings as being positioned on one surface or the other, it being understood that such features can be positioned upon both opposing surfaces according to the invention.

As shown in FIG. 1, a prior art dental implant includes an implant body 20 affixed into the jaw bone of a patient (not shown). An abutment 13 is affixed to the implant body 20 and a dental restorative prosthesis such as a crown 21 is affixed to the abutment. In normal practice, abutment 13 is affixed to implant body 20 by a threaded screw (not shown) or other device, and crown 21 is cemented to the abutment 13. A cement gap 22 is intentionally designed into this arrangement to allow space for the cement material (not shown).

As shown in the prior art series of drawing FIGS. 2-7, the presence of cement gap 22 can lead to misalignment of the dental prosthesis 21. FIGS. 2 and 5 show a dental prosthesis 21 correctly aligned on abutment 13. FIGS. 3 and 6 however, show a potential translational misalignment. FIGS. 4 and 7 show a rotational misalignment.

According to the present invention, dry-fit features or bumps 11 are provided upon a surface such as outer surface 13a or abutment 13 that extend into cement gap 22. Preferably, each bump 11 is similarly sized and are placed at various locations about surface 13a, such that crown 21 having an interior surface 21a is correctly positioned upon the support surface 13b or abutment 13 in a correctly aligned manner. Further still each bump 11 is preferably extends into cement gap 22 to a distance such that each physically touches or engages interior surface 21a of crown 21. The longest dimension of a given bump 11 may even be slightly greater than the cement cap 22 dimension when crown 21 is placed upon abutment 13 or other support. In this manner, it will be appreciated that before cementation or the filling of cement gap 22 with cement, crown 21 may be placed upon its intended support surface such as abutment 13 and will be temporarily retained in its correct alignment to be reviewed by the dental practitioner. If dimensioned properly, a friction fit between bumps 11 and the opposing surface such as interior surface 21a of crown 21 may be created by the physical engagement, thereby securely yet temporarily holding crown 21 to abutment 13 during the dry-fit procedure. Once the correct alignment has been confirmed and the crown removed, cement may be applied and the crown re-seated upon the abutment 13. Bumps 11 ensure correct replacement of crown 21 in the positioned confirmed during dry-fit, without compromising the integrity of the ensuing cement bond.

Although any number of dry-fit features or bumps 11 may be employed, it is preferred to use at least three. It will also be appreciated that bumps 11 may be placed regularly or irregularly spaced upon a support surface 13a at any location. As shown in FIGS. 8 and 9, bumps 11 are positioned upon outer or support surface 13a of abutment 13, including along its sides and top portion. FIG. 10 shows bumps 11 only on the sides of support surface 13a. Bumps 11 may be fabricated from the same material as abutment 13 or some other material such as the material from which crown 21 is fabricated. Bumps 11 may be hard or resilient.

Dry-fit features of bumps 11 may also be placed upon the interior 21a of dental prosthesis or crown 21, as is shown in FIGS. 12 and 13. They may also be positioned upon both a support surface 13a and an interior surface 21a simultaneously. Bumps 11 should be placed upon one, the other or both opposing surfaces when crown 21 is placed upon its support surface such as surface 13a of abutment 13.

According to another embodiment of the present invention, a dental prosthesis 21 having bumps 11 on its interior surface 21a as described above, may be supported upon the prepared surface 30 of a tooth 31. A cement gap 22 is provided as also above described. Bumps 11 serve to allow the dental practitioner to dry-fit crown 21 upon prepared surface 30 of tooth 31, and to facilitate proper alignment and securing during such dry-fit and during the subsequent cementation step. Other than being positioned upon a prepared surface 30 of a tooth 31, the invention is utilized in a manner as characterized hereinabove.

In still another embodiment of the present invention as shown in FIGS. 15 and 16, a dental prosthesis such as a crown 21 is provided with dry-fit features or bumps 11 as above, and the opposing surface 21a is provided with physically opposing detents 40 configured to accept an opposing bump 11. This further supports crown 21 upon its support surface such as support surface 13a of abutment 13 by physical contact of a given bump 11 and its corresponding detent 40. Although several or more bumps 11 and detent 40 combinations are shown in the drawings, it is within the scope of the invention to provide a single bump 11 and corresponding detent 40, or a plurality of such configured combinations. Of course, as with bumps 11 as discussed above, either opposing surface or both opposing surfaces may be configured with bumps 11 and/or detents 40, as exemplified in FIGS. 17 and 18.

Similarly, as shown in FIGS. 19 and 20, at least one groove 50 may be provided in the interior surface of crown 21, such that a bump 11 or a plurality of bumps 11 may be configured to enter groove 50 when crown 21 is placed upon its support surface such as support surface 13a of abutment 13. The physical interaction between a given bump 11 and groove 50 further supports crown 21 during the above described dry-fit and cementation steps. Again, either opposing surface or both opposing surfaces may be provided with grooves 50 and corresponding bumps 11.

In restorative dentistry, cement retained restorations are typically built using three components:
1. An implant embedded in the patient's jaw bone
2. An abutment screwed into the implant
3. And, a crown that is cemented to the abutment

During the fitting procedure in doctor's office, the crown is placed on the abutment without cement to test its shape and give an opportunity for adjustments prior to final cementation. We call this “dry-fitting.”

The typical restorative procedure is shown in FIG. 1.

The inner surface of the crown is designed to be slightly larger than the outer surface of the abutment it is intended to be cemented to. This is to provide room for the cement. This extra space is called a cement gap. See FIG. 2.

There are a few problems that need to be overcome because of the need for this cement gap:
1. The two parts do not dry-fit together snugly, and may in fact fall apart if not physically held together during the procedure, prior to cementation.
2. The two parts can move relative to one another by an amount equal to the size of the cement gap. This effect happens translationally, but there is a similar effect rotationally. As a result, adjustments made to the crown during the dry-fit, may be off by the amount of the cement gap after cementation. See FIGS. 3 and 4.

This invention helps address these problems by adding as set of small features between the crown and abutment. These small features (in one incarnation spherical bumps on the abutment wall) are slightly bigger than the cement gap. Yet, they take up very little of the surface area to be bonded by cement. As a result, the two parts are modified by a manufacturing process to have the following additional characteristics:
1. The features cause slight interference that acts to resist the tendency of the two parts to fall apart. That is, these features provide dry-fit retention between the two parts.
2. The features take up space to position the two parts relative to one another more precisely than the gap needed for proper cementation. The positional error is therefore limited to the precision of the machining process, which is much smaller than the position error created by the larger cement gap.
3. The features allow sufficient space for cementation, such that a dental practitioner won't see a reduction in the cementation characteristics. We suspect that the resulting evenness of cementation will actually result in a stronger bond than traditional cementation procedures.

FIG. 5 shows the incarnation of the features where the features are implemented as spherical bumps on the abutment wall.

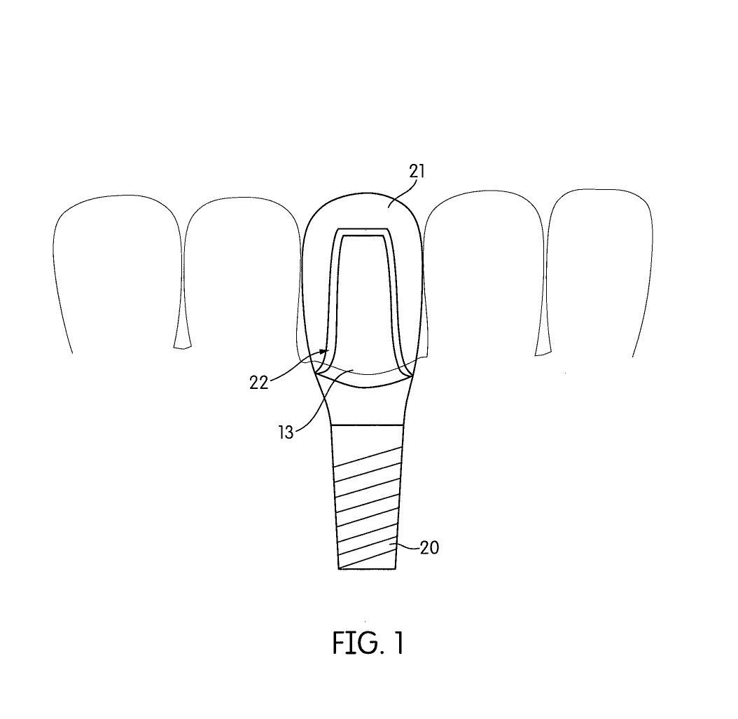

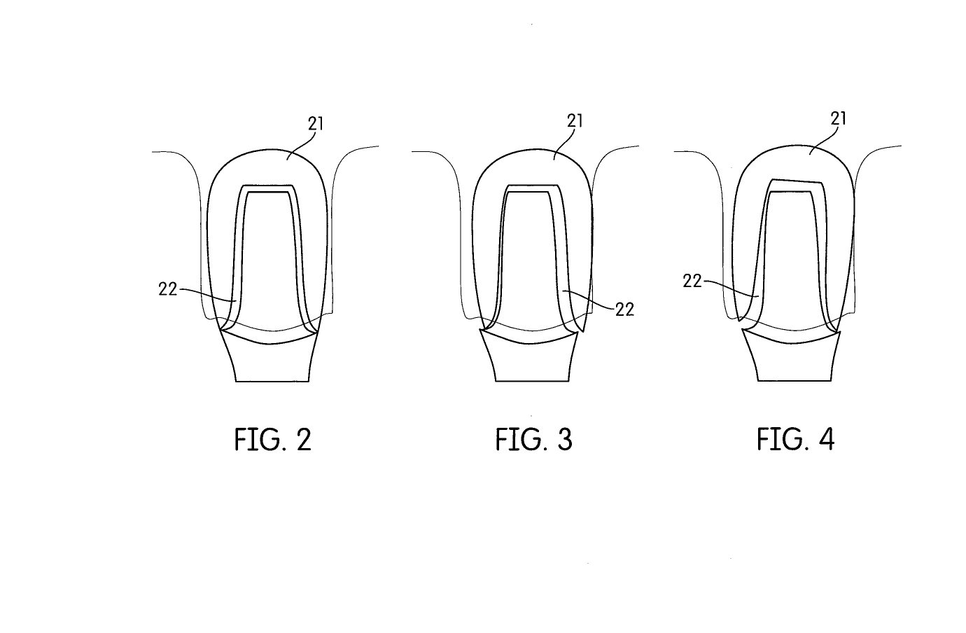

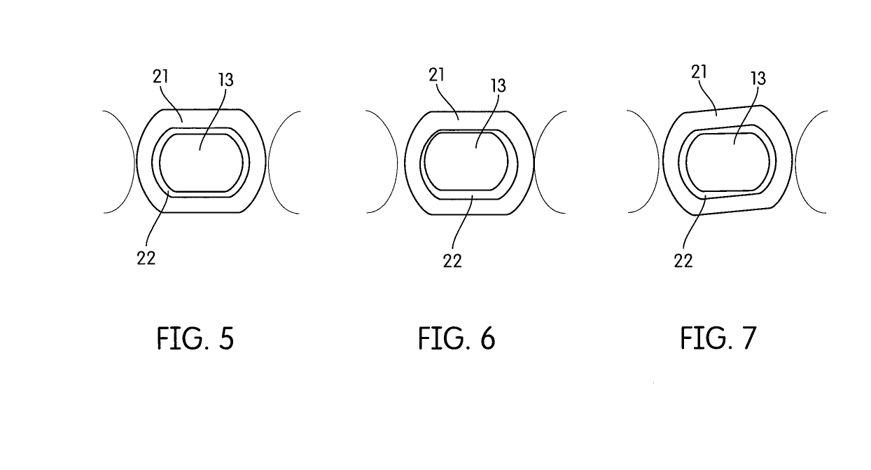

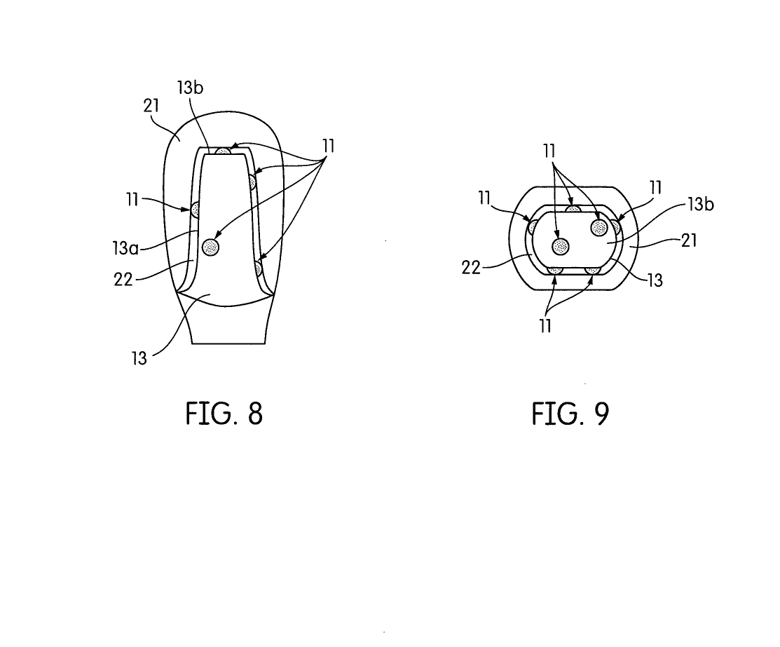

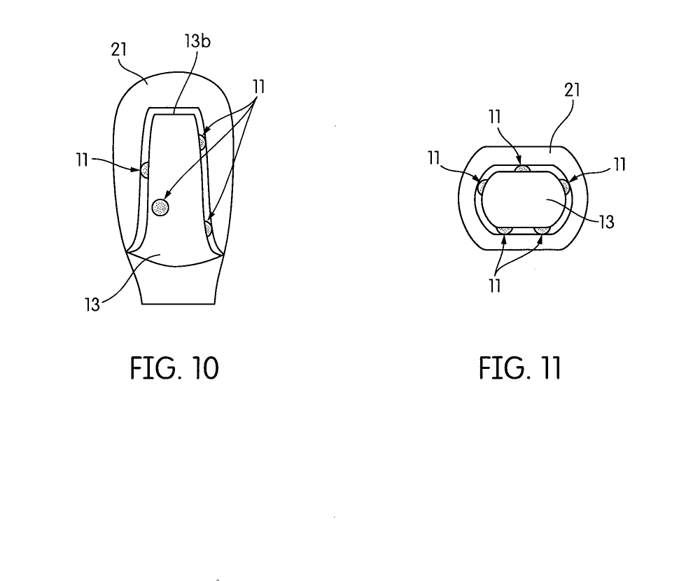

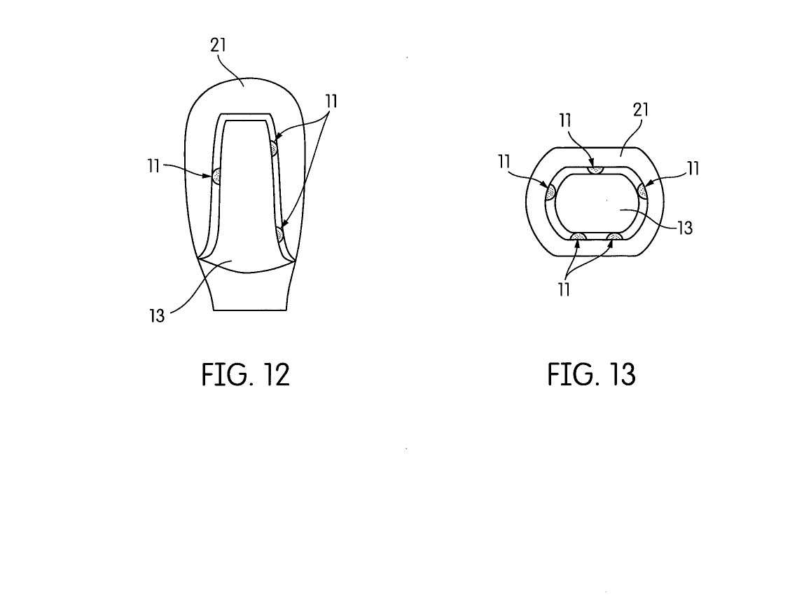

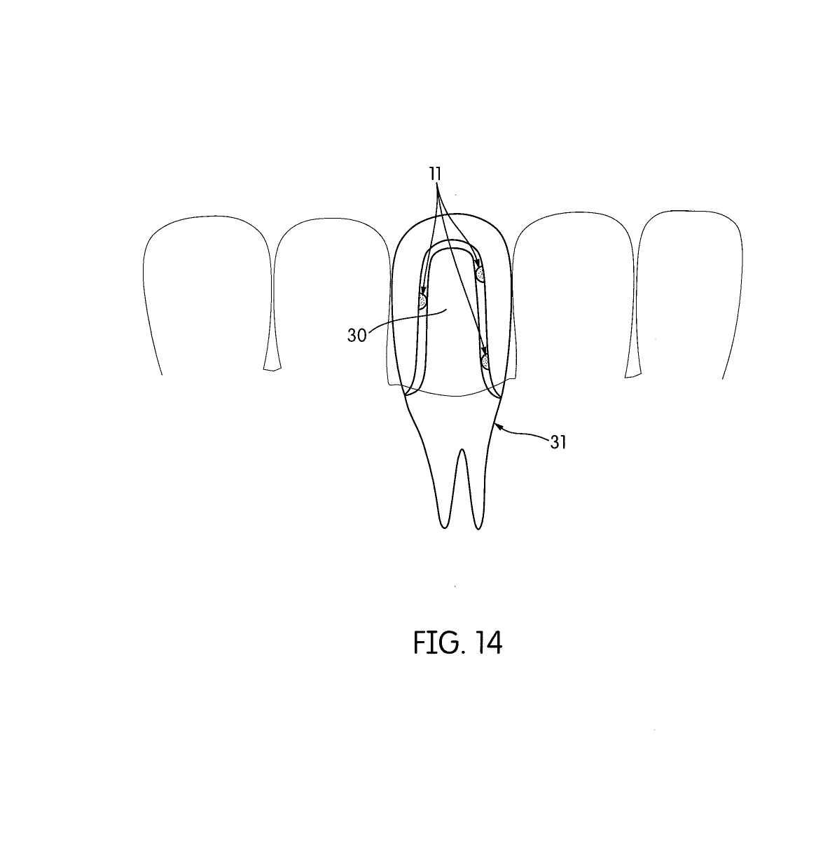

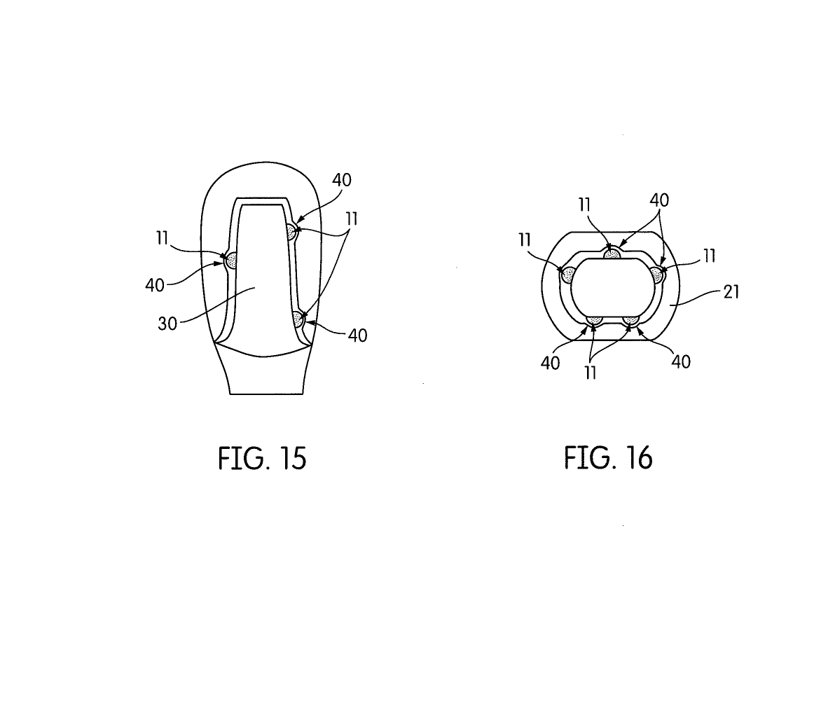

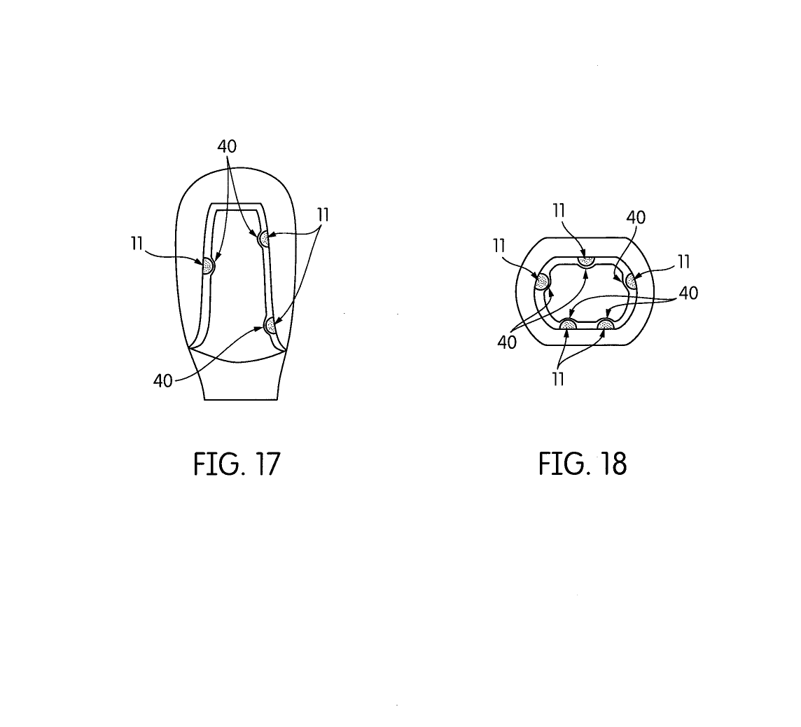

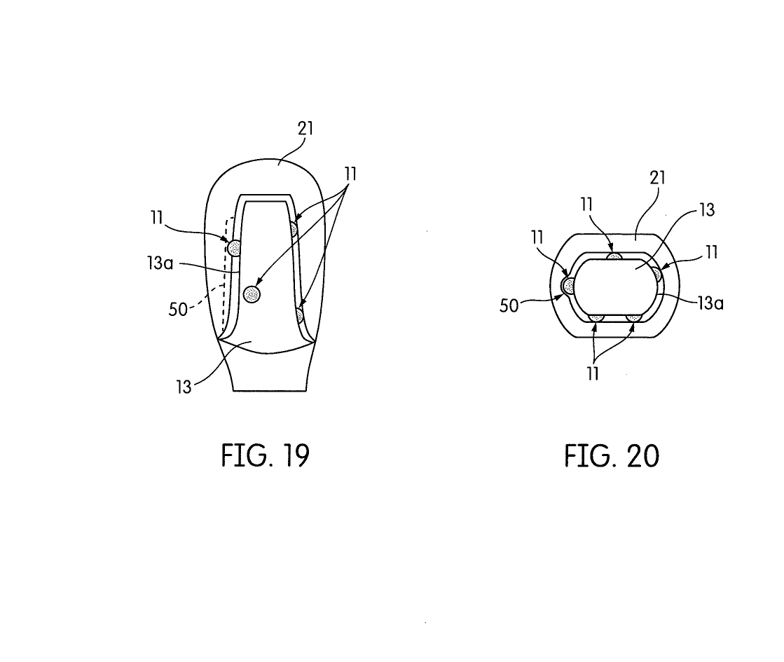

The method described here is to digitally apply small features on either surface in contact with the cement gap to meet the following conditions:
1. They are small enough to take up less than 1% of the total cemented area.
2. They are positioned such that they are slightly larger than the cement gap, to provide slight interference between the two parts, and hence frictional retention between the two parts in dry-fit.
3. They are positioned such that they are not so large as to inhibit the complete mating of the two parts. The exact amount depends on the material, geometry of the feature, size of the cement gap and machining tolerances. This can be determined either by experiment or by mathematically modelling the deformation characteristics of an appropriate range of geometries of the custom dental components.
4. There are a sufficient number of features radially such that they inhibit radial translation and rotation.
5. They are distributed radially such that they inhibit radial translation and rotation.
6. There are a sufficient number of features vertically such that they inhibit vertical translation and rotation.
7. They are distributed vertically such that they inhibit vertical translation and rotation.
8. To satisfy items 4-7, there need to be a minimum of 3 features widely dispersed between the abutment and crown.

It is helpful to explain more about the need for a minimum of 3 features as noted in item 8 above. In mechanics, objects are described as having six degrees of freedom: translation in the x, y and z directions, and rotation about the x, y and z axes. Preventing an object from moving requires restricting its movement in these six degrees of freedom.

Note that some disciplines refer to twelve degrees of freedom. This is no different than the six mentioned in that each linear direction has both positive and negative motion, and each rotational direction has both clockwise and counterclockwise motions. In practice, is can be useful to think of restricting motion by restricting both directions of each degree for a total of twelve degrees of freedom to restrict. Some people clear up this apparent confusion by describing twelve degrees of “movement” in the six degrees of “freedom.”

You can restrict movement in a linear direction by putting an obstacle in the path of that movement. That obstacle can take the form of a rigid feature that resists motion. Sometimes this is accomplished by clamping, which uses friction as a block to movement. The exact needs to restrict all six degrees of freedom depend on the geometry of the object to be restricted. (For example, you can't restrict rotational motion of a sphere with point obstacles alone, but must also include some clamping force to resist the rotation.)

Manufacturing generally accepts that it takes six point locations plus one clamp to restrict motion of a generic object. It is easy to see that linear motion can be restricted in all three degrees of freedom by six points. A single clamp can add restrictions on all the rotational aspects.

Irregular shapes can be constrained without clamps, but clamps make the problem easier. Imagine the case of a cube. It can be constrained linearly by a single point obstacle on each surface. With perfect rigid objects, those six points will also prevent rotation. This would happen because as the cube rotates relative to the points, the distance between the two points on the surface of the cube would get bigger. In practice, the amount of flexibility in the cube material, and the point obstacles allow for a certain amount of linear and rotational play. Different counts of points, locations of the points and the addition of clamps can improve the amount of resistance the part has to movement.

In the case of a custom abutment and crown configuration, these items are typically irregular in shape, which makes fixing their relative locations easier to solve. To restrict most linear motion requires three points on the vertical walls of the interface and one point to restrict vertical motion along the axis of the abutment core. But, for a crown connection, there is another constraint that simplifies the problem. There is medical value to having the crown and the abutment have as close to no cement gap as possible along the margin edge where they meet. That is, we want the crown and abutment to touch along the marginal edge.

The reason for this is that research shows that cement can irritate soft tissue, so dental practitioners work to limit contact with cement against the tissue. We help my designing the crown and the abutment to mate as tightly as possible in this region, to the extent possible using machining techniques to provide this zero cement gap feature. It is well known in basic mechanics that such a connection will actually be in precise contact in at least 3 points, and we can count on this relationship to provide 3 of our needed contact points, while also maintaining the correct marginal fit.

The result though is that we can fully constrain the cap motion in 11 of the 12 degrees of freedom by taking advantage of the vertical restriction imposed by the margin contact, and adding at least 3 distributed contact points around the core of the abutment (or inner surface of the crown).

These four points will not restrict the crown from slipping off the abutment. For this we need a clamping force, which is achieved by making at least two of the points on vertical surface bigger than the cement gap, providing clamping friction induced by the force of overcoming the interference during insertion.

With an irregular cross section, the three points on the vertical section are sufficient to prevent axial rotation. But, to restrict rotation along the two other rotational directions requires the contacts created by the intimate contact with the margin. Together with the contacts along the abutment walls these provide at least three obstacles when the part is rotated about the axis created by any two other points.

In this way, a minimum of six points and one induced clamping force is sufficient to both locate and constrain the relative positions of a crown and abutment in a dry-fit situation.

(There is the possibility that the mating surface forms a perfect cylinder. In this case, a system can be designed that restricts rotation about the central axis of the cylinder using clamping. But there is no system that can deterministically locate such a cylinder, just prevent its rotation. Fortunately, in restorative dentistry, with patient specific crowns and abutments, it is extremely unlikely that a specific case would have such a perfectly cylindrical mating surface. A practitioner can correctly ignore this edge case. And, should it actually occur sufficiently often to warrant, a constraint can be added to the custom design process to prevent perfect cylindrical shapes.)

It is important to note that the proper location and constraint can be achieved by precise placement of three contact points. But, we can simplify the needed precision of placement by adding more points of constraint. So, while three points are the minimum, in practical application using more points simplifies the calculations needed and provides redundant support. But, adding more points need to be done with a mind to not overly reducing the area of cement application, and not excessively increasing the frictional forces applied between the two surfaces.

In practice, we can add as many contact points as we like so long as the total contact area is small enough to ensure sufficient remaining cement area on the part. We are currently practicing using 16 feature points distributed around the core of the abutment. This is partly to account for variability in the wall geometry of the abutment core. Abutments are affixed to the implant via a screw, and that screw is inserted via a screw access hole. The screw axis hole cuts through the abutment core surface someplace, and typically cuts away some of the abutment wall. Rather than calculate where the hole is and position a small number of contact points to avoid the hole, we add enough contact points such that there continue to be sufficient contact points no matter how many are cut away by the screw access hole.

There is no need for precision in the number of contact points in the abutment (or crown) wall. So long as there are at least three and you don't add so many that they don't leave sufficient room for cementation strength, you can pick any number that efficiently works for your placement calculation algorithm.

In addition, there is no need for precise placement of the contact points around the abutment core. So long as they are placed so that no radial span is large enough to allow translation of the part through the gap created, the radial distribution will be fine. In practice, this means that the parts should be distributed so that no radial span leaves a gap greater than or equal to 180 degrees.

Finally, there is no need for precise placement of the contact points vertically along the abutment core. The goal should be to distribute the points vertically, such that they take up greater than half of the total vertical span of the abutments. That is, the distance between the lowest point and the highest point should be greater than half of the abutment core. All the other points can be randomly distributed in the remaining vertical space. In practice, it makes sense to distribute them evenly in this space, but there is no mechanical need for this implementation.

Also, with truly rigid bodies, the two surfaces will naturally only come into contact with precisely six of the obstacle points. Adding more points would have no impact on theoretically perfect and rigid parts. That said, we do not have theoretical parts in the real world. Our parts yield when mated, and we take advantage of this feature of matter to induce friction. In this real-world view, many more than six points will interact contributing to the friction component. But, it is not necessary that more than six points engage, and in fact it is acceptable in practice of some of the extra points do not, in fact engage.

In other words, with more than three wall contact points, it is possible that (in fact likely) that some of the contact points will actually not be in contact with the opposite wall. In true force closure situations, this is undesirable, since force closure would want to precisely control which 3 points were in contact. In our invention, it is unimportant which three points are in contact, simply that there are 3 in contact. And the mechanics of the situation will also assure that at least three of the contact points will be naturally distributed so as to provide repeatable repositioning.

It is worth some notes on the size of the contact points. While we plan to practice a shape that is largely semi-spherical, there are only two factors that matter in this feature size and shape: the cross sectional area and the height of the feature from the surface it is placed on.

The cross sectional area needs to be large enough so that it has sufficient mechanical strength in the material it is manufactured out of to not break off in normal use. For our materials in their normal use, that means we need a cross sectional area on the order of 0.01 mm². Again, there is no need for precision here. This can be as large as you like so long as the total remaining area for cementation continues to be sufficient. In practice, the features could be as large a 1.0 mm², and still be small enough. This can be validated either experimentally or with a calculation based on remaining area and cementation needs.

The height of the features needs to be slightly larger than the cement gap. It cannot be smaller than the cement gap, or there will be no friction induced. But the exact extra height is difficult to describe precisely, and can be determined best by experimentation on specific material choices. The correct extra height depends on two factors. The first factor is the desired level of friction. The larger the interference, the greater the friction induced. This impacts both the finger force required to set the two parts together, and the amount of force needed to separate the two parts. This is incredibly difficult to calculate, and is best determined by experiment and user experience. The second factor is that the feature must be smaller than the elastic modulus of the two materials would cause either part to fracture. This can be determined using standard finite element analysis methodologies, or simple experimental techniques. But, it practice this is unnecessary, since the force required to fracture the material will (for most practical materials) be larger than could practically be applied by a finger pushing the two parts together.

In our implementation we use:
Spherical features
Attached to the abutment surface
16 in total
Distributed evenly radially
Distributed evenly vertically
But, while distributed evenly vertically, not in a regular progression as we advance radially around the abutment

### Comparison to Prior Art

There is prior art that uses a precise number of features such that the crown is placed in a precise location with each placement. This approach on its face seems remarkably similar to this proposed invention, but differs in a number of key ways and because of those differences is an inferior approach to this invention:
The prior art uses an exact number of contact points (6) to assure precise force closure, less the required clamping force. Our invention is flexible to the number of contact points, actually requiring a minimum of 3, and in practice we use 16 contact points. Our approach allows us to be flexible in placement in a way that allows screw-access hole cut-outs in the abutment wall to remove some number of the contact points, and still maintain the needed 3 contact point.
The prior art places the contact points so that no other part of the abutment and crown are in contact. This is problematic to good crown and abutment mating, because it is ideal to have the margin edge of the crown and the abutment be as close to intimate contact as possible. That is, there should be zero cement gap at the marginal interface between the two parts. The prior art forces the two parts to not be in intimate contact except at the precisely specified points, if any. Our invention relies on the intimate contact at the margin, to the extent possible using machining techniques to provide this zero cement gap feature. It is well known in basic mechanics that such a connection will actually be in precise contact in at least 3 points, and we can count on this relationship to provide 3 of our needed contact points, while also maintaining the correct marginal fit.
The prior art requires the contact points to have no more friction between the two parts than is needed by the clamping force required to hold the parts together. That is, if the clamping force is removed, the parts should simply separate in the direction of the clamping force. Our invention relies on an initial applied force (as by a finger placing the two parts together) applying a frictional force between the two parts which is maintained by the elastic moduli of the two parts after the applied force is removed. In other words, the prior art expects no interfering overlap between the two parts, and our invention intentionally induces such overlap to take advantage of it.
The prior art requires precise sizing of the contact points to be equal to the desired cement gap. And, while the exact size of the contact points may vary based on machining tolerances, the size of the cement gap will essentially be set by the size of the bumps. In this way the cement gap is an output of the process. In our invention, the size of the cement gap is an input to the process, and the size of the contact point features is set to be slightly bigger than the cement gap. The amount of overage determines the amount of insertion pressure required to induce sufficient friction for dry fit retention. And this invention is tolerant to variations in the contact feature size. Smaller size overages result in less retention, while larger overages result in greater retention. So long as the parts are no smaller than the actual cement gap, and not so large as to induce fracture in the material, they are fine.

At first glance it might seem difficult to distinguish between the force closure based prior art and our invention. In reality, there are a number of features that make distinguishing these two approaches easy:
Force closure will have only six contact points positioned around the abutment core. Our invention typically will have more than six.
Force closure will have contact points along the occlusal surface of the abutment (or crown) or will have contact points distributed along the margin of the abutment (or crown). Our invention will avoid these areas, as they restrict the margin from coming into intimate contact.
Force closure will result in a margin without intimate contact. Our invention will have the margin between the crown and abutment in largely intimate contact
Force closure positioned parts will slide freely apart. Our invention will hold the two parts in contact until some force is applied.

It will be appreciated:
First, standard research into locating features focus on using such features in a manufacturing process in conjunction with clamping forces. They expect that the two parts to be placed in precise relation with one another, and will include some clamping force to maintain that relationship. Such arrangements do not rely on friction for the clamping force. In addition, such arrangements work toward precise alignment, and make no allowance for trading off some alignment precision in order to gain the benefit of dry-fit friction retention.
Second, there are difficult technical challenges to be overcome to implement this properly. Notably, we have needed to figure out the correct amount of overlap to provide friction sufficient for dry-fit retention yet not so much interference to stop the parts from seating fully. And, we have had to figure out how many features to include such that the two parts don't move relative to one another, and that there continues to be sufficient bonding surface between the two parts. And, we have had to figure out at least one correct shape for the feature such that it can be manufactured with milling techniques but not create a shape that will gouge into the mating surface.
Finally, in dentistry, there is no external awareness of the existence of the problems that arise once parts are milled with sufficient precision, and so, we are not aware of any practitioners who have proposed a solution yet alone recognized the need for a solution.

What is claimed is:

1. A dental implant system comprising:
a. a dental implant body configured to be securable in a jaw bone;
b. an abutment secured or securable to said implant body and having a first end affixable to said implant body, and a second end configured to receive a dental prosthetic; and,
c. a dental prosthetic receivable on and cementable to said second end of said abutment, such that an outer surface of second end of said abutment is positioned opposite to an inner surface of said dental prosthetic when said dental prosthetic is received on said second end of said abutment;
wherein a cement gap is configured between said abutment and said dental prosthetic when said dental prosthetic is received on said abutment; and wherein said outer surface of said abutment is provided with a plurality of regularly or irregularly spaced dry-fit features, such that when said dental prosthetic is received on said second end of said abutment, said dry-fit features create a removable friction fit between said outer surface of said second end of said abutment and said dental prosthetic.

2. A dental implant system as in claim 1, wherein said dry-fit features are configured as substantially spherical protrusions from said outer surface of said second end of said abutment.

3. A dental system as in claim 2, wherein said outer surface of said second end of said abutment is provided with at least three said dry-fit features.

4. A dental implant system as in claim 1 wherein said inner surface of said dental prosthetic is provided with at least one dry-fit feature receiving detent corresponding to at least one said dry-fit feature when said dental prosthetic is received on said second end of said abutment, such that a removable snap-fit retention is created.

5. A dental implant system comprising:
a. a dental implant body configured to be securable in a jaw bone;
b. an abutment secured or securable to said implant body and having a first end affixable to said implant body, and a second end configured to receive a dental prosthetic; and,
c. a dental prosthetic receivable on and cementable to said second end of said abutment, such that an outer surface of second end of said abutment is positioned opposite to an inner surface of said dental prosthetic when said dental prosthetic is received on said second end of said abutment;
wherein a cement gap is configured between said abutment and said dental prosthetic when said dental prosthetic is received on said abutment; and wherein said inner surface of said dental prosthetic is provided with a plurality of regularly or irregularly spaced dry-fit features, such that when said dental prosthetic is received on said second end of said abutment, said dry-fit features create a removable friction fit between said inner surface of said dental prosthetic and said second end of said dental abutment.

6. A dental implant system as in claim 5, wherein said dry-fit features are configured as substantially spherical protrusions from said inner surface of said dental prosthetic.

7. A dental system as in claim 6, wherein said inner surface of said dental prosthetic is provided with at least three said dry-fit features.

8. A dental implant system as in claim 5 wherein said outer surface of said second end of said abutment is provided with at least one dry-fit feature receiving detent corresponding to at least one said dry-fit feature when said dental prosthetic is received on said second end of said abutment, such that a removable snap-fit retention is created.

9. A dental restoration comprising:
a prepared tooth having a preparation surface;
a dental prosthetic having an inner surface receivable on said preparation surface;
wherein a cement gap is configured between said preparation surface and said dental prosthetic when said dental prosthetic is received on said preparation surface; and wherein said inner surface of said dental prosthetic is provided with a plurality of regularly or irregularly spaced dry-fit features, such that when said dental prosthetic is received on said preparation surface, said dry-fit features create a removable friction fit between said inner surface of said dental prosthetic and said preparation surface.

10. A dental restoration as in claim 9, wherein said dry-fit features are configured as substantially spherical protrusions from said inner surface of said dental prosthetic.

11. A dental restoration as in claim 10, wherein said inner surface of said dental prosthetic is provided with at least three said dry-fit features.

12. A dental restoration system as in claim 9, wherein said outer surface of said dental prosthetic is provided with at least one dry-fit feature receiving detent corresponding to at least one said dry-fit feature when said dental prosthetic is received on said preparation surface, such that a removable snap-fit retention is created.
